(19) United States
(12) Patent Application Publication
(10) Pub. No.: US 2018/0308133 A1
(43) Pub. Date: Oct. 25, 2018

(54) Generating Personalized Messages According To Campaign Data

(71) Applicant: Facebook, Inc., Menlo Park, CA (US)

(72) Inventors: James F. Geist, JR., Issaquah, WA (US); Dan Barak, Redwood City, CA (US); John Stephen Ketchpaw, Seattle, WA (US)

(21) Appl. No.: 15/491,293

(22) Filed: Apr. 19, 2017

(51) Int. Cl. G06Q 30/02; G06Q 50/00; G06N 99/00

(52) U.S. Cl. CPC G06Q 30/0271; G06N 99/005; G06Q 50/01

(57) ABSTRACT

In one embodiment, a method includes receiving a request to initiate a messaging campaign. The request may comprise campaign rules. The method may also include sending, to each of several users, one or more messages associated with the messaging campaign; receiving, from each of the users, a response to each of the messages; updating campaign data associated with the messaging campaign based on the responses from each of the plurality of users; accessing user data associated with a first user of a social-networking system; accessing the updated campaign data of the users; and determining, by a machine-learning model, a message associated with the messaging campaign. The message may be based on the user data of the first user and the updated campaign data, and satisfies the one or more rules for the messaging campaign. Finally, the method may include generating the message for presentation to the first user.

### TECHNICAL FIELD

This disclosure generally relates to sending customized messages over an online network.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, the social-networking system may use a machine learning model to determine a personalized offer in a message to a user of the online social network. The offer may be based on aggregate user data, personal user data of the individual user who receives the message, one or more messaging campaign parameters, and current data associated with the messaging campaign for the particular message. As an example and not by way of limitation, a third-party entity (e.g., an advertiser) may launch a messaging campaign (e.g., an advertising campaign). The third-party entity may set one or more campaign parameters (e.g., duration of the messaging campaign, total amount of spend), that may include an offer-type and an offer range. The offer may be a discount for goods or services, a buy-one-get-one type offer, or any other suitable offer. As an example of an offer range, the third-party entity may specify a percentage discount of between 10% and 50%. Once the third-party entity has specified the messaging campaign parameters including the offer range, the social networking system may identify individual users to whom send the message with the offer. The social-networking system may use a trained machine learning model to determine an offer amount with the offer range for each user. As an example and not by way of limitation, the social-networking system may identify a user Alex to receive an message that includes a percentage-discount offer. The machine learning model may determine that the offer amount for Alex should be 36%. As a result, the social-networking system may send Alex a message that says “Buy today an get a 36% discount.”

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example interface that includes a message with a general offer.

FIG. 2 illustrates an example interface that includes a message with a personalized offer for a particular user.

FIG. 3 illustrates an example method for determining a personalized offer in a message to a user of an online social network.

FIG. 4 illustrates an example network environment associated with a social-networking system.

FIG. 5 illustrates an example social graph.

FIG. 6 illustrates an example computer system.

### DESCRIPTION OF EXAMPLE EMBODIMENTS

In particular embodiments, the social-networking system may use a machine learning model to determine a personalized offer in a message to a user of the online social network. The offer may be based on aggregate user data, personal user data of the individual user who receives the message, one or more messaging campaign parameters, and current data associated with the messaging campaign for the particular message. As an example and not by way of limitation, a third-party entity (e.g., an advertiser) may launch a messaging campaign (e.g., an advertising campaign). The third-party entity may set one or more campaign parameters (e.g., duration of the messaging campaign, total amount of spend), that may include an offer-type and an offer range. The offer may be a discount for goods or services, a buy-one-get-one type offer, or any other suitable offer. As an example of an offer range, the third-party entity may specify a percentage discount of between 10% and 50%. Once the third-party entity has established the messaging campaign parameters including the offer range, the social networking system may identify individual users to whom send the message with the offer. The social-networking system may use a trained machine learning model to determine an offer amount with the offer range for each user. As an example and not by way of limitation, the social-networking system may identify a user Alex to receive a message that includes a percentage-discount offer. The machine learning model may determine that the offer amount for Alex should be 36%. As a result, the social-networking system may send Alex a message that says “Buy today an get a 36% discount.”

In particular embodiments, to determine the personalized offer, the social-networking system may, in response to receiving a request to initiate a messaging campaign, send messages to a plurality of users associated with the messaging campaign. The social-networking system may receive a response from each of the users to each of the messages. The social-networking system may use the responses to update campaign data associated with the messaging campaign. In particular embodiments the social-networking system may access user data associated with a particular user and may also access the updated campaign data. The social-networking system may also use a machine learning model to determine a message associated with the messaging campaign. The message may include an offer that is personalized for the particular user based on the user data associated with the particular user. As an example and not by way of limitation, the message may include an offer that is personalized for Alex that says “Buy today and get a 36% discount.” In particular embodiments, the message may not include an offer. As an example and not by way of limitation, the message may be a news article, marketing materials, a blog post, a video, a link, or any other suitable content. The message may also satisfy one or more rules (e.g., campaign parameters) for the messaging campaign. The social-networking system may also generate the message including the offer for presentation to the particular user. Although this disclosure describes determining a personalized offer in a particular manner, this disclosure contemplates determining a personalized offer in any suitable manner.

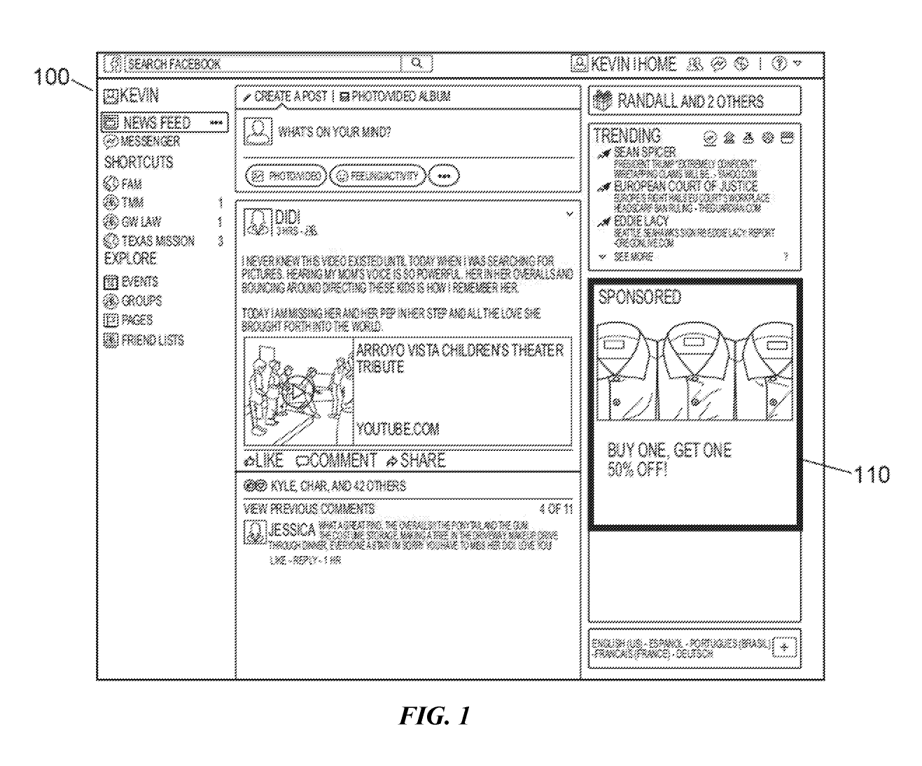

FIG. 1 illustrates an example interface 100 that includes a message 110. In particular embodiments, the message 110 may comprise an offer. In the example interface 100, the offer may be that the user will receive 50% off his purchase of a second shirt if he purchases a first shirt. The amount of the offer has traditionally been decided by a third-party entity (e.g., an advertiser) and has generally remained fixed throughout the duration of the messaging campaign (e.g., advertising campaign). The social-networking system has traditionally used social networking data of its users to determine to whom to send the message and offer, but the offer has traditionally been determined by the advertiser and has remained fixed throughout the messaging campaign. As an example and not by way of limitation, VERIZON WIRELESS may run a messaging campaign on the online social network, and the message may be sent with the following offer: “Subscribe today and get 50% off a Droid smartphone.” The 50%-off discount may be the offer. This amount is typically set by the advertiser and it does not change throughout the ad campaign.

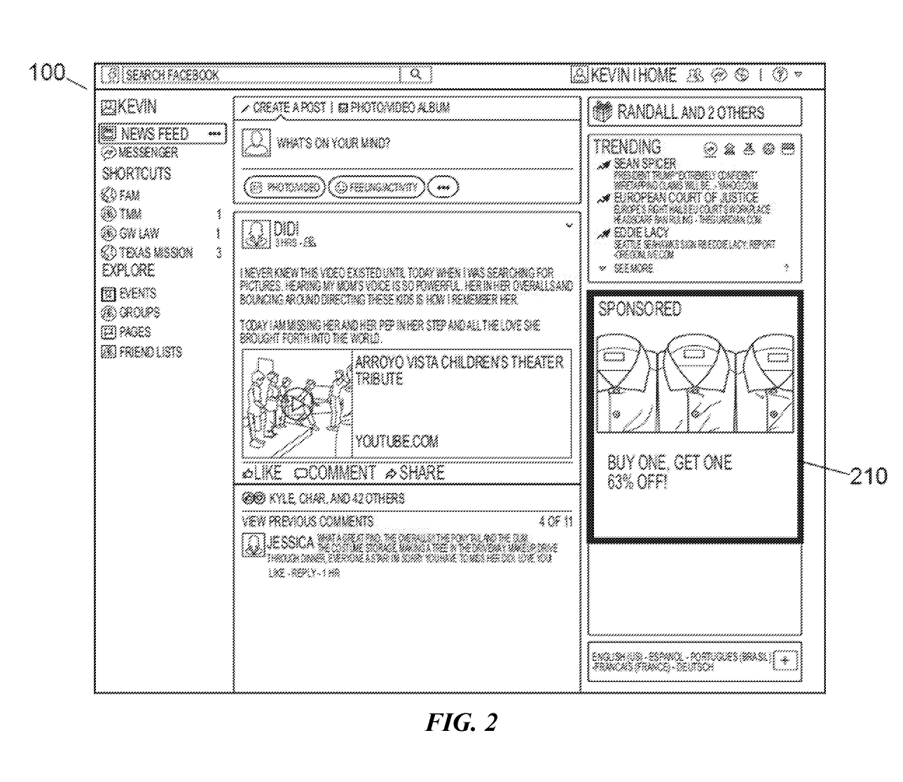

FIG. 2 illustrates an example interface 100 that includes a message 210. The message 210 may comprise a personalized offer for a particular user. In the example interface 100, the offer is that the user will receive 63% off his purchase of a second shirt if he purchases a first shirt. In this example the 63%-off offer is a personalized offer that has been determined for that particular user by the social-networking system. In particular embodiments, the social-networking system may use a dynamic pricing model (e.g., machine-learning model) to determine a precise offer amount that falls within an offer range. The offer range may have been set previously by the third-party entity, such as during campaign creation. The offer range may be any suitable range (e.g., 40%-70% off). As an example and not by way of limitation, VERIZON WIRELESS may run a messaging campaign that includes an offer on the online social network. VERIZON WIRELESS may need to set an offer range for the offer. The offer range may be any suitable range (e.g., 10% to 60% off). When a message of a messaging campaign is sent to a particular user Karen of the online social network, the message may include an offer that says, “Subscribe today and get 37% off a Droid smartphone.” When the social-networking system sends an advertisement to another user, the message associated with the advertisement may say “Subscribe today and get 58% off a Droid smartphone.” The amount of the discount (e.g., 36% or 58%) may be determined by the dynamic pricing model (e.g., machine learning model) in real-time or very close to real-time. How the social-networking system determines the personalized message with a personalized offer is discussed in more detail below. In particular embodiments, the personalized message may be based on live campaign data of the messaging campaign. Message 210 need not appear on a side panel of interface 100. As an example and not by way of limitation, message 210 may appear as a content object in a news feed of a first user, or in any other suitable location. Although this disclosure describes sending a message with a personalized offer to a user in a particular manner, this disclosure contemplates sending a message with a personalized offer to a user in any suitable manner.

In particular embodiments, the social-networking system may receive, from a client device of an entity, a request to initiate a messaging campaign. A messaging campaign may be understood to mean an organized course of action for sending users messages over the online social network. As an example and not by way of limitation, a messaging campaign may be an advertising campaign, and the messages may be advertisements. In particular embodiments, the entity may be a third-party entity that operates independently of the social-networking system. As an example and not by way of limitation, the third-party entity may be a clothing retailer (e.g., JCREW). JCREW may request to initiate an advertising campaign for a particular line of men's dress shirts that it wishes to sell to members of the online social network. In particular embodiments, the request to initiate the messaging campaign may comprise one or more campaign rules for the messaging campaign. The campaign rules may be rules that govern how much money the entity wishes to spend on the messaging campaign, the duration of the messaging campaign (e.g., a start-date and an end-date), target demographics (e.g., employed men living in cities with populations above 250,000 people), and one or more optimizations for the messaging campaign. As an example and not by way of limitation, the clothing retailer JCREW may specify one or more rules that the messaging campaign should adhere to. These rules may include, for example, a rule that the messaging campaign should begin on Jun. 1, 2017 and should run for three months. Another rule may be that the total amount the messaging campaign should cost (e.g., in a pay-per click (PPC) scheme) be below 310,000. Another rule may be that the maximum cost per click in a PPC scheme is 35.00. Another rule may be that the maximum discount rate on any offer for goods should be 60%. The optimizations may be stated in terms of goals for the messaging campaign (e.g., acquire new customers, re-activate old customers, retain current customers, total units sold, number of offers accepted, total number of clicks on advertisements related to the messaging campaign). As an example and not by way of limitation, an optimization for the clothing retailer JCREW may be to attract new customers (e.g., users who have not purchased clothing at JCREW in the past). To attract new customers, the social-networking system may offer bigger discounts to users who have never shopped at JCREW before. Alternatively, the social-networking system may offer bigger discounts to users who have never viewed content related to JCREW, who have never “liked” JCREW on the online social network, or who have never clicked-through to a JCREW website from a content object associated with JCREW and posted on the online social network. Although this disclosure describes receiving a request to initiate a messaging campaign in a particular manner, this disclosure contemplates receiving a request to initiate a messaging campaign in any suitable manner.

In particular embodiments, the campaign rules may comprise a rule to modify the message. Modifying the message may include altering an offer amount, altering some other content in the message, (e.g., colors, text, photos), exchanging the message for another message altogether, changing the offer type, or any other suitable change. In particular embodiments, the campaign rules may comprise a rule to modify the message in particular circumstances. As an example and not by way of limitation, the campaign rules may comprise a rule to modify the message if the messaging campaign is within a threshold number of days from an end date of the messaging campaign. As another example and not by way of limitation, the campaign rules may comprise a rule to modify the message if the conversion rate for the message is below a threshold conversion rate, or if the amount of ad spend is above or below a threshold level, or for any other suitable reason. As an example and not by way of limitation, one of the campaign rules may specify that if the overall conversion rate is below 10% and the campaign is within seven days of ending, the social-networking system should be more aggressive in its offer amounts in the messages. As a result of this rule, if the overall conversion rate is below 10% and the messaging campaign is within seven days of ending, the social-networking system may increase the offer amounts for one or more offers. As another example and not by way of limitation, the messaging campaign may be a news campaign run by a new news station that is trying to attract viewers. The messages may be notifications of news articles, or entire news articles. The campaign rules for this messaging campaign may instruct the social-networking system to change the heading for a headline if the click-through rate after a particular amount of time (e.g., 5 hours) for a particular headline is below a threshold value. As another example and not by way of limitation, the campaign rules may instruct the social-networking system to exchange a particular news article with another news article if the click-through rate after a particular amount of time (e.g., 5 hours) for a particular headline is below a threshold value. Although this disclosure describes receiving a request to initiate a messaging campaign in a particular manner, this disclosure contemplates receiving a request to initiate a messaging campaign in any suitable manner.

In particular embodiments, the entity may be requested to specify an offer to accompany the message that will be sent in association with the messaging campaign. The offer may be a presentation in a message to a user that requests the user use perform some action (e.g., buy a product or service, interact with a content object, click through to a third-party website), and in exchange for the action, either the social-networking system or a third-party entity may give the user some benefit (e.g., a discount, a free item, discounted access to content or service). The offer may comprise an offer type and a discount range. The offer type may be any suitable offer type, including a percentage discount (e.g., “get 30% off”), a dollar discount (e.g., “get 315 off”) a buy-one-get-one type offer (e.g., “buy one shirt, get one free;” “buy two shirts, get one free”), or any other suitable offer. The discount range may be set by the third-party entity and may be any suitable discount range, including a percentage discount range (e.g., any discount range between 0% and 100%), a dollar discount range (e.g., any discount range between 30 and the price of the product or service), or any other suitable discount range (e.g., an offer that says “subscribe today and receive 11 days free”). In particular embodiments, an offer may include a time-frame (e.g., “Subscribe in the next 2 days and get 50% off a Droid smartphone”), or a dollar discount (e.g., “Subscribe today and get 3214 off a Droid smartphone”). An offer may also be a BOGO-type offer (e.g., buy two, get one free), or an offer based on user interaction (share/like/subscribe/comment and get 25% off). An offer may comprise any combination of these elements.

In particular embodiments, when a third-party entity wishes to launch a messaging campaign over the online social network, the third-party entity may navigate via web browser to the online social network and select the appropriate icon for starting a new messaging campaign (e.g., an icon that states: “start a new ad campaign”). In particular embodiments, the social-networking system may send the third-party entity an interface that allows the third-party entity to select the type of offer for the messaging campaign (e.g., percentage discount, dollar discount, BOGO discount). In particular embodiments, the third-party entity may then specify the offer range (e.g., 20-50% off). In particular embodiments, the third-party entity may then specify one or more rules for the messaging campaign (e.g., duration, max ad spend, max discount spend, target audience, target geographic region). In particular embodiments, the third-party entity may also select one or more goals to optimize for (e.g., acquire new users, re-activate old users, retain current users). In particular embodiments, the third-party entity may also select one or more discount rules (e.g., decrease the discount once a threshold number of users convert; increase the discount right before the ad campaign expires if there is still discount spend or ad spend remaining). In particular embodiments, the campaign rules may comprise the offer type, the discount range, the discount rules, the duration of the campaign, the target audience, the optimizations, and any other suitable parameter for the messaging campaign. Although this disclosure describes launching a messaging campaign in a particular manner, this disclosure contemplates launching a messaging campaign in any suitable manner.

In particular embodiments, a machine-learning model may be trained with training data. The training data may include a list of user features and a list of message features. The user features may include any suitable user feature, such as age, race, employment status, relationship status, geographic location, educational background, as well as social graph data, such as content objects that users have interacted with (e.g., liked, shared, commented on). The social graph data may also include affinity coefficients between users and other users, content objects, concepts, or any other suitable entity on the online social network, as discussed below. All this information may be referred to as aggregate user data. The message features may include any suitable characteristic of the message, including the content of the message, the product or server the message is promoting (if the message is an advertisement), the offer-type of the offer in the message, the offer amount, photos or other multimedia content in the message, or any other suitable feature of the message. The training data may also be labeled by whether a particular user has clicked on or otherwise interacted with the particular message. As an example and not by way of limitation, a click-through may be labeled as “1,” and if the user hides or ignores the message, that may be labeled as “0.” In particular embodiments, the label may also be any other indicator of a desired result, such as a user accepting an offer, liking a message, sharing a message, or even lingering on a message for an unusual period of time instead of scrolling past the message. In particular embodiments, the label may be the offer amount at which each user accepted the offer or converted on the message (e.g., by clicking on the message). In this case, the machine learning model predicts the offer amount rather than the probability a user will click on a particular message with a particular offer amount. In particular embodiments, campaign data may be used as training data or an input to the machine learning model that has already been trained. As an example and not by way of limitation, the training data may include campaign data across one or more messaging campaigns. The campaign data may include, among other things, a conversion rate, a total number of conversions, the age of the messaging campaign, the time until the end of the messaging campaign, the demographics of users who convert or who do not convert, or any other suitable data. In particular embodiments, the machine learning model may use any suitable algorithm to train on, including a regression model, a neural network, or any other suitable algorithm. As an example and not by way of limitation, the algorithm may be a linear regression model of the type f(x)=w₁A+w₂B+w₃C . . . +wᵢZ, where A, B, C . . . Z are user features and message features and w₁, w₂ . . . wᵢ may be weights for the features that may be determined during training. Although this disclosure describes training a machine-learning model in a particular manner, this disclosure contemplates training a machine-learning model in any suitable manner.

In particular embodiments, the machine-learning model may be trained using data from “lookalike” users with respect to the first user. A lookalike user may be a user who has similar attributes as the first user. The principle here is that similar users may behave similarly when viewing a particular message. As an example and not by way of limitation, two users, Alex and Brandon, may both be male and may have both interacted with (e.g., liked, viewed, shared, commented on) content objects related to weightlifting and bodybuilding. Alex and Brandon may be lookalike users. That is, Alex may be a lookalike user with respect to Brandon, and vice versa. Thus, if Brandon has converted (e.g., purchased a product) for a particular health supplement, Alex may be likely to also convert on the health supplement. In particular embodiments, the lookalike users are selected from a plurality of second users. As an example and not by way of limitation, if a user Alex is the first user, the lookalike users may be selected from a group of second users. This group of second users may be all other users on the online social network, or may be a subset of all users (e.g., users who live in North America). In particular embodiments, the first user may correspond to a first user-vector and the plurality of second users correspond to a plurality of second user-vectors, respectively. The social-networking system may determine whether users A and B are lookalike users by representing each user as a user-vector. After the social-networking system has generated user-vectors for two or more users, it may measure the vector similarity (e.g., cosine similarity, Euclidean distance) between two user-vectors to determine if the users may be deemed to be lookalike users. A user may be considered a lookalike user with respect to the querying user if, for example, the cosine similarity between their respective user-vectors is above a threshold similarity value. As an example and not by way of limitation, a user a user Alex may be a Mexican-American male, aged 24, who attends Stanford University, and who has liked the Tim Duncan fan page, and has checked-in at Umami Burger in Palo Alto, Calif. Each of these pieces of information relating to Alex's social-networking activity may be coded and become part of a user-vector that represents Alex. The social-networking system may create a user-vector for Alex that may look something like, <2, 5, 0, 0, 3, −2>, where each value in the user-vector represents some social-networking trait (e.g., 2=male, 5=age 21-25; −2=likes Tim Duncan). This user-vector may have more or fewer dimensions depending on the number of social-networking traits considered when determining lookalikes and the amount of information available to the social-networking system. If two users have a vector similarity value above a threshold similarity value (e.g., a cosine similarity greater than 0.7), they may be deemed to be lookalike users. Depending on the threshold, the querying user may have tens, hundreds, or thousands of lookalike users. Thus, in particular embodiments, each user-vector is an N-dimensional vector representing the respective user in an N-dimensional vector space. Each dimension of the user-vector may correspond to a social-networking trait of the respective user. In particular embodiments, each lookalike user may be selected based on a vector similarity between the first user-vector and the second-user vector corresponding to the lookalike user. Using data from a first user's lookalike users may allow the social-networking system to more accurately predict whether the first user will convert on a particular message and offer. Although this disclosure describes using lookalike user data in a particular manner, this disclosure contemplates using lookalike user data in any suitable manner. More information on identifying lookalike users and using the associated data to make predictions is disclosed in U.S. patent application Ser. No. 15/337,832, entitled “Ranking Search Results Based on Lookalike Users on Online Social Networks” and filed 28 Oct. 2016, which is incorporated herein by reference.

In particular embodiments, once the machine-learning model has been trained, feature data for new users and new messages may be used in conjunction with the campaign rules and the campaign status to predict whether or not a particular user will click on a particular message with a given offer amount, or predict the offer amount likely to be accepted. As an example and not by way of limitation, the social-networking system may take the trained machine-learning model and apply it to a particular user, Alex and a particular message of a messaging campaign. For example, the message may be message 210. In particular embodiments, the machine-learning model may accept as input Alex's user features as well as the message features. In particular embodiments, one of the message features may be the offer amount. In particular embodiments, the machine-learning model may output a probability score for each of several different offer amounts within the offer range. As an example and not by way of limitation, the social-networking system may determine the probability that Alex will click on a message that has discounts of 18%, 20%, 22%, 24%, etc., and may select the offer amount that is associated with the highest click-through probability. In particular embodiments, the social-networking system may select the offer associated with a click-through probability that is the first to plateau. For example, the probability that Alex will click on messages with different offer amounts may be expressed in the table below:

| Offer Amount | Probability that Alex will Click |
|---|---|
| 18% off | .2 |
| 20% off | .3 |
| 22% off | .4 |
| 24% off | .4 |

Because the probability that Alex will click does not change between a 22% discount and a 24% discount, the social-networking system may select the 22% discount to accompany the message that is sent to Alex. In particular embodiments, the social-networking system may be programmed to select the lowest offer amount whose associated probability is within a threshold probability from the next highest probability. As an example and not by way of limitation, the threshold probability may be 0.05. If the probabilities that a user will click on a 25% discount, 30% discount and 35% discount are 0.3, 0.4, and 0.45, respectively, the social-networking system may select the 30% discount for the particular user. The third-party entity (e.g., advertiser) may specify a rule such as this in the campaign rules. Although this disclosure describes selecting an offer amount in a particular manner, this disclosure contemplates selecting an offer amount in any suitable manner.

In particular embodiments, the social-networking system may send, to each of a plurality of users, one or more messages associated with the messaging campaign. These messages may be generic messages with static offer amounts, or they may be messages with personalized offer amounts that have been determined by the social-networking system with the aid of the machine-learning model. As an example and not by way of limitation, the social-networking system may send messages similar to message 110 or 210 to many different users. The purpose of sending these messages may be in part to determine how the messaging campaign will perform over the duration of the messaging campaign, and to provide the social-networking system with some quick feedback on the message and offer. In particular embodiments, in response to sending the messages, the social-networking system may receive, from each of the plurality of users, a response to each of the one or more messages. A response to a message may include any one or more of the following: clicking on or otherwise selecting the message, liking the message, sharing the message, hiding the message, ignoring the message, scrolling quickly past the message, hovering a cursor over the message, gazing at the message (as may be determined with a front-facing camera associated with a computing device of a user), blocking the message, or any other suitable interaction with the message. The social-networking system may keep track of the responses for each sent message in the messaging campaign, as well as the associated offer and offer amount accompanying each message. Although this disclosure describes sending and receiving messages in a particular manner, this disclosure contemplates sending and receiving messages in any suitable manner.

In particular embodiments, the social-networking system may update campaign data associated with the messaging campaign. The update may be based on the received responses from the plurality of users. The campaign data may be any data relevant to the messaging campaign. The campaign data may include a total conversion rate for the messaging campaign, conversion rate for particular offers, offer amounts, types of users, or any other suitable metric. The campaign data may also include total advertising spend (e.g., the amount paid to the social-networking system based on a PPC scheme), total discount spend (e.g., the total amount of discounts offered as a dollar amount or as a percentage of some other metric like total costs), or other conversion statistics. The other conversion statistics may include the type of device from which a response was performed, the time of day at which a response was performed, user data (e.g., as discussed above) associated with the response, or any other suitable statistic. Although this disclosure describes updating campaign data in a particular manner, this disclosure contemplates updating campaign data in any suitable manner.

In particular embodiments, the social-networking system may access user data associated with a first user of the online social network. The user data may be expressed as user features and may include any suitable data associated with the first user, as discussed previously. The user data may include any suitable user data, such as age, race, employment status, relationship status, geographic location, educational background, as well as social graph data, such as content objects that users have interacted with (e.g., liked, shared, commented on). The social graph data may also include affinity coefficients between users and other users, content objects, concepts, or any other suitable entity on the online social network, as discussed below. User data may also include conversion data of the first user. As an example and not by way of limitation, the first user may be male, 34 years old, live in Santa Fe, N. Mex., and work at BEST BUY, a consumer electronics store. The first user may also have conversion data associated with his social-networking profile. The conversion data may contain information about past conversions the user has made in relation to advertisements sent by the social-networking system. A conversion may be an action performed by the user that is a desired object of a message (e.g., buy a product, watch a video, share a message). Although this disclosure describes accessing user data in a particular manner, this disclosure contemplates accessing user data in any particular manner.

In particular embodiments, the social-networking system may access the previously updated campaign data. The social-networking system may access the previously updated campaign data to assess how the campaign is doing. The social-networking system may determine how much total ad-spend has accrued, how much time is left in the messaging campaign, what the conversion rate is, or any other suitable metric. The campaign data may include a total conversion rate for the messaging campaign, conversion rate for particular offers, offer amounts, types of users, or any other suitable metric. The campaign data may also include total advertising spend (e.g., the amount paid to the social-networking system based on a PPC scheme), total discount spend (e.g., the total amount of discounts offered as a dollar amount or as a percentage of some other metric like total costs), or other conversion statistics. Although this disclosure describes accessing previously updated campaign data in a particular manner, this disclosure contemplates accessing previously updated campaign data in any suitable manner.

In particular embodiments, the social-networking system may determine, by the machine-learning model, a message associated with the messaging campaign. The message may be based on the accessed user data of the first user of the online social network. The message may also be based on the accessed updated campaign data. The message may also satisfy one or more of the campaign rules previously set by the third-party entity. As an example and not by way of limitation, the accessed user data may include social networking data, demographic data, and conversion data. The updated campaign data may indicate that the messaging campaign is currently one week from ending and that the current overall conversion rate is 5%. One of the campaign rules may specify that if the overall conversion rate is below 10% and the campaign is within seven days of ending, offer more aggressive offer amounts in the messages. As a result of this, the social-networking system may increase the offer amounts for one or more offers. In particular embodiments, the social-networking system may send to the user the message with the personalized message. As an example and not by way of limitation, the social-networking system may send the following message to a particular user: “Buy a shirt today and get 22% off” Although this disclosure describes determining a message associated with the messaging campaign in a particular manner, this disclosure contemplates determining a message associated with the messaging campaign in any suitable manner.

In particular embodiments, the social-networking system may send to the third-party entity an indication that a user has converted. Traditionally, when a user has converted, the social-networking system may have sent an indication to the third-party entity in the form of a static label. As an example and not by way of limitation, the static label may have been “SNS20,” which may mean that the conversion came from the messaging campaign associated with the social-networking system and a 20% discount. But because the offer amount may no longer be a static amount, a static label like “SNS20” may no longer provide the necessary information. Thus, the social-networking system may send a different label to the advertiser. As an example and not by way of limitation, the label may be SNS[CampaignName][DiscountAmount], where CampaignName is the name of the messaging campaign, and DiscountAmount is the amount of the offer. Thus, if a campaign is called TShirts and the discount given to a particular user is 19%, the label may be SNSTShirts19%. If the discount is 35, the label could be SNSTShirts35. Although this disclosure describes sending an indication that a user has converted in a particular manner, this disclosure contemplates sending an indication that a user has converted in any suitable manner.

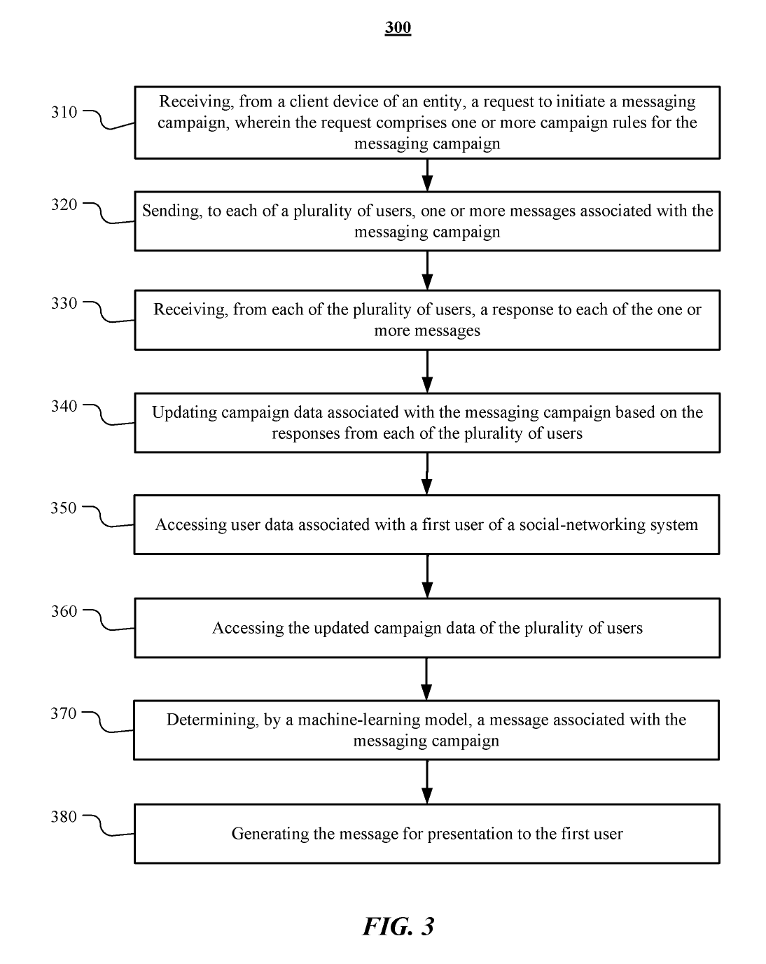

FIG. 3 illustrates an example method 300 for determining a personalized offer in a message to a particular user of an online network. The method may begin at step 310, where the social-networking system may receive, from a client device of an entity, a request to initiate a messaging campaign. The request may comprise one or more campaign rules for the messaging campaign. At step 320, the social-networking system may send, to each of a plurality of users, one or more messages associated with the messaging campaign. At step 330, the social-networking system may receive, from each of the plurality of users, a response to each of the one or more messages. At step 340, the social-networking system may update campaign data associated with the messaging campaign based on the responses from each of the plurality of users. At step 350, the social-networking system may access user data associated with a first user of a social-networking system. At step 360, the social-networking system may access the updated campaign data of the plurality of users. At step 370, the social-networking system may determining, by a machine-learning model, a message associated with the messaging campaign. The message may be based on the user data of the first user and the updated campaign data of the plurality of users. The message may also satisfy the one or more rules for the messaging campaign. At step 380, the social-networking system may generate the message for presentation to the first user. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for determining a personalized offer in a message to a particular user of an online network including the particular steps of the method of FIG. 3, this disclosure contemplates any suitable method for determining a personalized offer in a message to a particular user of an online network including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

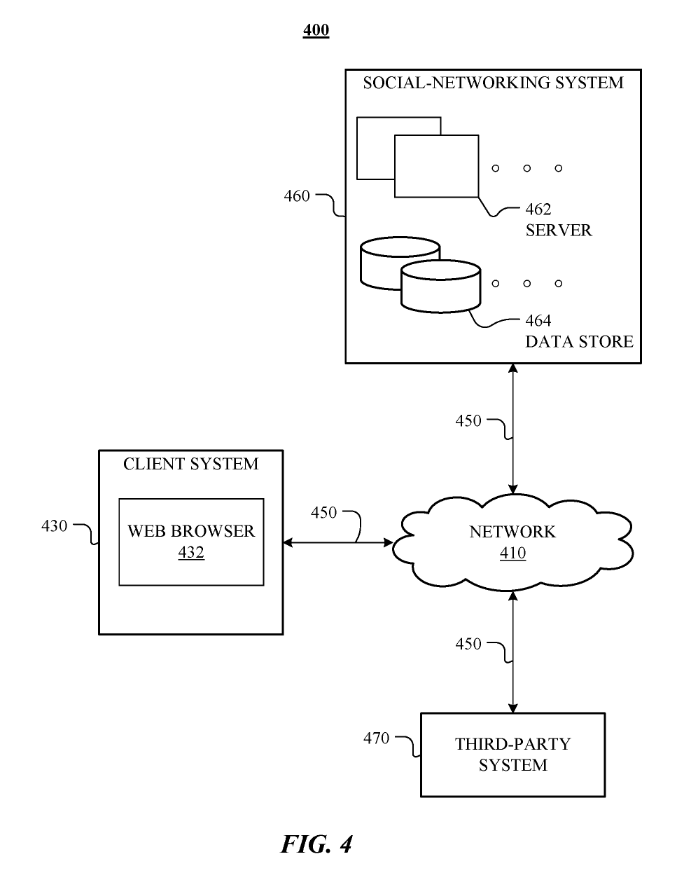

FIG. 4 illustrates an example network environment 400 associated with a social-networking system. Network environment 400 includes a client system 430, a social-networking system 460, and a third-party system 470 connected to each other by a network 410. Although FIG. 4 illustrates a particular arrangement of client system 430, social-networking system 460, third-party system 470, and network 410, this disclosure contemplates any suitable arrangement of client system 430, social-networking system 460, third-party system 470, and network 410. As an example and not by way of limitation, two or more of client system 430, social-networking system 460, and third-party system 470 may be connected to each other directly, bypassing network 410. As another example, two or more of client system 430, social-networking system 460, and third-party system 470 may be physically or logically co-located with each other in whole or in part. Moreover, although FIG. 4 illustrates a particular number of client systems 430, social-networking systems 460, third-party systems 470, and networks 410, this disclosure contemplates any suitable number of client systems 430, social-networking systems 460, third-party systems 470, and networks 410. As an example and not by way of limitation, network environment 400 may include multiple client system 430, social-networking systems 460, third-party systems 470, and networks 410.

This disclosure contemplates any suitable network 410. As an example and not by way of limitation, one or more portions of network 410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 410 may include one or more networks 410.

Links 450 may connect client system 430, social-networking system 460, and third-party system 470 to communication network 410 or to each other. This disclosure contemplates any suitable links 450. In particular embodiments, one or more links 450 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 450 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 450, or a combination of two or more such links 450. Links 450 need not necessarily be the same throughout network environment 400. One or more first links 450 may differ in one or more respects from one or more second links 450.

In particular embodiments, client system 430 may be an electronic device including hardware, software, or embedded logic components or a combination of two or more such components and capable of carrying out the appropriate functionalities implemented or supported by client system 430. As an example and not by way of limitation, a client system 430 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 430. A client system 430 may enable a network user at client system 430 to access network 410. A client system 430 may enable its user to communicate with other users at other client systems 430.

In particular embodiments, client system 430 may include a web browser 432, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 430 may enter a Uniform Resource Locator (URL) or other address directing the web browser 432 to a particular server (such as server 462, or a server associated with a third-party system 470), and the web browser 432 may generate a Hyper Text Transfer Protocol (HTTP) request and communicate the HTTP request to server. The server may accept the HTTP request and communicate to client system 430 one or more Hyper Text Markup Language (HTML) files responsive to the HTTP request. Client system 430 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 460 may be a network-addressable computing system that can host an online social network. Social-networking system 460 may generate, store, receive, and send social-networking data, such as, for example, user-profile data, concept-profile data, social-graph information, or other suitable data related to the online social network. Social-networking system 460 may be accessed by the other components of network environment 400 either directly or via network 410. As an example and not by way of limitation, client system 430 may access social-networking system 460 using a web browser 432, or a native application associated with social-networking system 460 (e.g., a mobile social-networking application, a messaging application, another suitable application, or any combination thereof) either directly or via network 410. In particular embodiments, social-networking system 460 may include one or more servers 462. Each server 462 may be a unitary server or a distributed server spanning multiple computers or multiple datacenters. Servers 462 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 462 may include hardware, software, or embedded logic components or a combination of two or more such components for carrying out the appropriate functionalities implemented or supported by server 462. In particular embodiments, social-networking system 460 may include one or more data stores 464. Data stores 464 may be used to store various types of information. In particular embodiments, the information stored in data stores 464 may be organized according to specific data structures. In particular embodiments, each data store 464 may be a relational, columnar, correlation, or other suitable database. Although this disclosure describes or illustrates particular types of databases, this disclosure contemplates any suitable types of databases. Particular embodiments may provide interfaces that enable a client system 430, a social-networking system 460, or a third-party system 470 to manage, retrieve, modify, add, or delete, the information stored in data store 464.

In particular embodiments, social-networking system 460 may store one or more social graphs in one or more data stores 464. In particular embodiments, a social graph may include multiple nodes—which may include multiple user nodes (each corresponding to a particular user) or multiple concept nodes (each corresponding to a particular concept)—and multiple edges connecting the nodes. Social-networking system 460 may provide users of the online social network the ability to communicate and interact with other users. In particular embodiments, users may join the online social network via social-networking system 460 and then add connections (e.g., relationships) to a number of other users of social-networking system 460 to whom they want to be connected. Herein, the term “friend” may refer to any other user of social-networking system 460 with whom a user has formed a connection, association, or relationship via social-networking system 460.

In particular embodiments, social-networking system 460 may provide users with the ability to take actions on various types of items or objects, supported by social-networking system 460. As an example and not by way of limitation, the items and objects may include groups or social networks to which users of social-networking system 460 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 460 or by an external system of third-party system 470, which is separate from social-networking system 460 and coupled to social-networking system 460 via a network 410.

In particular embodiments, social-networking system 460 may be capable of linking a variety of entities. As an example and not by way of limitation, social-networking system 460 may enable users to interact with each other as well as receive content from third-party systems 470 or other entities, or to allow users to interact with these entities through an application programming interfaces (API) or other communication channels.

In particular embodiments, a third-party system 470 may include one or more types of servers, one or more data stores, one or more interfaces, including but not limited to APIs, one or more web services, one or more content sources, one or more networks, or any other suitable components, e.g., that servers may communicate with. A third-party system 470 may be operated by a different entity from an entity operating social-networking system 460. In particular embodiments, however, social-networking system 460 and third-party systems 470 may operate in conjunction with each other to provide social-networking services to users of social-networking system 460 or third-party systems 470. In this sense, social-networking system 460 may provide a platform, or backbone, which other systems, such as third-party systems 470, may use to provide social-networking services and functionality to users across the Internet.

In particular embodiments, a third-party system 470 may include a third-party content object provider. A third-party content object provider may include one or more sources of content objects, which may be communicated to a client system 430. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 460 also includes user-generated content objects, which may enhance a user's interactions with social-networking system 460. User-generated content may include anything a user can add, upload, send, or “post” to social-networking system 460. As an example and not by way of limitation, a user communicates posts to social-networking system 460 from a client system 430. Posts may include data such as status updates or other textual data, location information, photos, videos, links, music or other similar data or media. Content may also be added to social-networking system 460 by a third-party through a “communication channel,” such as a newsfeed or stream.

In particular embodiments, social-networking system 460 may include a variety of servers, sub-systems, programs, modules, logs, and data stores. In particular embodiments, social-networking system 460 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 460 may also include suitable components such as network interfaces, security mechanisms, load balancers, failover servers, management-and-network-operations consoles, other suitable components, or any suitable combination thereof. In particular embodiments, social-networking system 460 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 460 to one or more client systems 430 or one or more third-party system 470 via network 410. The web server may include a mail server or other messaging functionality for receiving and routing messages between social-networking system 460 and one or more client systems 430. An API-request server may allow a third-party system 470 to access information from social-networking system 460 by calling one or more APIs. An action logger may be used to receive communications from a web server about a user's actions on or off social-networking system 460. In conjunction with the action log, a third-party-content-object log may be maintained of user exposures to third-party-content objects. A notification controller may provide information regarding content objects to a client system 430. Information may be pushed to a client system 430 as notifications, or information may be pulled from client system 430 responsive to a request received from client system 430. Authorization servers may be used to enforce one or more privacy settings of the users of social-networking system 460. A privacy setting of a user determines how particular information associated with a user can be shared. The authorization server may allow users to opt in to or opt out of having their actions logged by social-networking system 460 or shared with other systems (e.g., third-party system 470), such as, for example, by setting appropriate privacy settings. Third-party-content-object stores may be used to store content objects received from third parties, such as a third-party system 470. Location stores may be used for storing location information received from client systems 430 associated with users. Advertisement-pricing modules may combine social information, the current time, location information, or other suitable information to provide relevant advertisements, in the form of notifications, to a user.

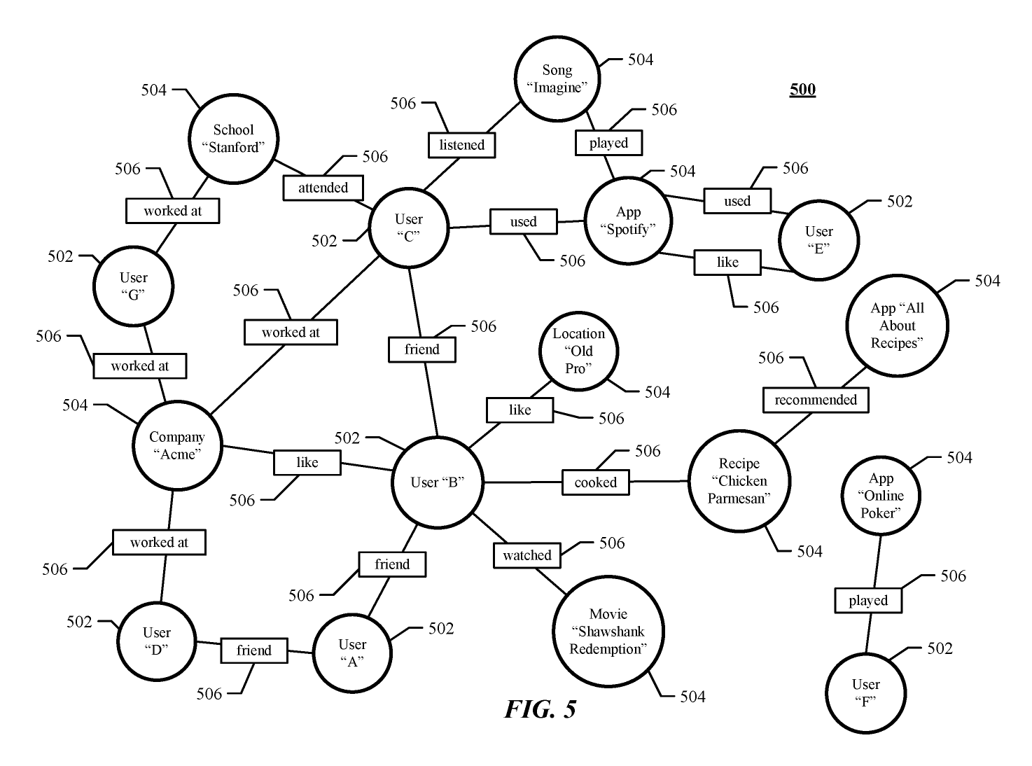

FIG. 5 illustrates example social graph 500. In particular embodiments, social-networking system 460 may store one or more social graphs 500 in one or more data stores. In particular embodiments, social graph 500 may include multiple nodes—which may include multiple user nodes 502 or multiple concept nodes 504—and multiple edges 506 connecting the nodes. Example social graph 500 illustrated in FIG. 5 is shown, for didactic purposes, in a two-dimensional visual map representation. In particular embodiments, a social-networking system 460, client system 430, or third-party system 470 may access social graph 500 and related social-graph information for suitable applications. The nodes and edges of social graph 500 may be stored as data objects, for example, in a data store (such as a social-graph database). Such a data store may include one or more searchable or queryable indexes of nodes or edges of social graph 500.

In particular embodiments, a user node 502 may correspond to a user of social-networking system 460. As an example and not by way of limitation, a user may be an individual (human user), an entity (e.g., an enterprise, business, or third-party application), or a group (e.g., of individuals or entities) that interacts or communicates with or over social-networking system 460. In particular embodiments, when a user registers for an account with social-networking system 460, social-networking system 460 may create a user node 502 corresponding to the user, and store the user node 502 in one or more data stores. Users and user nodes 502 described herein may, where appropriate, refer to registered users and user nodes 502 associated with registered users. In addition or as an alternative, users and user nodes 502 described herein may, where appropriate, refer to users that have not registered with social-networking system 460. In particular embodiments, a user node 502 may be associated with information provided by a user or information gathered by various systems, including social-networking system 460. As an example and not by way of limitation, a user may provide his or her name, profile picture, contact information, birth date, sex, marital status, family status, employment, education background, preferences, interests, or other demographic information. In particular embodiments, a user node 502 may be associated with one or more data objects corresponding to information associated with a user. In particular embodiments, a user node 502 may correspond to one or more webpages.

In particular embodiments, a concept node 504 may correspond to a concept. As an example and not by way of limitation, a concept may correspond to a place (such as, for example, a movie theater, restaurant, landmark, or city); a website (such as, for example, a website associated with social-network system 460 or a third-party website associated with a web-application server); an entity (such as, for example, a person, business, group, sports team, or celebrity); a resource (such as, for example, an audio file, video file, digital photo, text file, structured document, or application) which may be located within social-networking system 460 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 504 may be associated with information of a concept provided by a user or information gathered by various systems, including social-networking system 460. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 504 may be associated with one or more data objects corresponding to information associated with concept node 504. In particular embodiments, a concept node 504 may correspond to one or more webpages.

In particular embodiments, a node in social graph 500 may represent or be represented by a webpage (which may be referred to as a “profile page”). Profile pages may be hosted by or accessible to social-networking system 460. Profile pages may also be hosted on third-party websites associated with a third-party system 470. As an example and not by way of limitation, a profile page corresponding to a particular external webpage may be the particular external webpage and the profile page may correspond to a particular concept node 504. Profile pages may be viewable by all or a selected subset of other users. As an example and not by way of limitation, a user node 502 may have a corresponding user-profile page in which the corresponding user may add content, make declarations, or otherwise express himself or herself. As another example and not by way of limitation, a concept node 504 may have a corresponding concept-profile page in which one or more users may add content, make declarations, or express themselves, particularly in relation to the concept corresponding to concept node 504.

In particular embodiments, a concept node 504 may represent a third-party webpage or resource hosted by a third-party system 470. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 430 to send to social-networking system 460 a message indicating the user's action. In response to the message, social-networking system 460 may create an edge (e.g., a check-in-type edge) between a user node 502 corresponding to the user and a concept node 504 corresponding to the third-party webpage or resource and store edge 506 in one or more data stores.

In particular embodiments, a pair of nodes in social graph 500 may be connected to each other by one or more edges 506. An edge 506 connecting a pair of nodes may represent a relationship between the pair of nodes. In particular embodiments, an edge 506 may include or represent one or more data objects or attributes corresponding to the relationship between a pair of nodes. As an example and not by way of limitation, a first user may indicate that a second user is a “friend” of the first user. In response to this indication, social-networking system 460 may send a “friend request” to the second user. If the second user confirms the “friend request,” social-networking system 460 may create an edge 506 connecting the first user's user node 502 to the second user's user node 502 in social graph 500 and store edge 506 as social-graph information in one or more of data stores 464. In the example of FIG. 5, social graph 500 includes an edge 506 indicating a friend relation between user nodes 502 of user “A” and user “B” and an edge indicating a friend relation between user nodes 502 of user “C” and user “B.” Although this disclosure describes or illustrates particular edges 506 with particular attributes connecting particular user nodes 502, this disclosure contemplates any suitable edges 506 with any suitable attributes connecting user nodes 502. As an example and not by way of limitation, an edge 506 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 500 by one or more edges 506.

In particular embodiments, an edge 506 between a user node 502 and a concept node 504 may represent a particular action or activity performed by a user associated with user node 502 toward a concept associated with a concept node 504. As an example and not by way of limitation, as illustrated in FIG. 5, a user may “like,” “attended,” “played,” “listened,” “cooked,” “worked at,” or “watched” a concept, each of which may correspond to an edge type or subtype. A concept-profile page corresponding to a concept node 504 may include, for example, a selectable “check in” icon (such as, for example, a clickable “check in” icon) or a selectable “add to favorites” icon. Similarly, after a user clicks these icons, social-networking system 460 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 460 may create a “listened” edge 506 and a “used” edge (as illustrated in FIG. 5) between user nodes 502 corresponding to the user and concept nodes 504 corresponding to the song and application to indicate that the user listened to the song and used the application. Moreover, social-networking system 460 may create a “played” edge 506 (as illustrated in FIG. 5) between concept nodes 504 corresponding to the song and the application to indicate that the particular song was played by the particular application. In this case, “played” edge 506 corresponds to an action performed by an external application (SPOTIFY) on an external audio file (the song “Imagine”). Although this disclosure describes particular edges 506 with particular attributes connecting user nodes 502 and concept nodes 504, this disclosure contemplates any suitable edges 506 with any suitable attributes connecting user nodes 502 and concept nodes 504. Moreover, although this disclosure describes edges between a user node 502 and a concept node 504 representing a single relationship, this disclosure contemplates edges between a user node 502 and a concept node 504 representing one or more relationships. As an example and not by way of limitation, an edge 506 may represent both that a user likes and has used at a particular concept. Alternatively, another edge 506 may represent each type of relationship (or multiples of a single relationship) between a user node 502 and a concept node 504 (as illustrated in FIG. 5 between user node 502 for user “E” and concept node 504 for “SPOTIFY”).

In particular embodiments, social-networking system 460 may create an edge 506 between a user node 502 and a concept node 504 in social graph 500. As an example and not by way of limitation, a user viewing a concept-profile page (such as, for example, by using a web browser or a special-purpose application hosted by the user's client system 430) may indicate that he or she likes the concept represented by the concept node 504 by clicking or selecting a “Like” icon, which may cause the user's client system 430 to send to social-networking system 460 a message indicating the user's liking of the concept associated with the concept-profile page. In response to the message, social-networking system 460 may create an edge 506 between user node 502 associated with the user and concept node 504, as illustrated by “like” edge 506 between the user and concept node 504. In particular embodiments, social-networking system 460 may store an edge 506 in one or more data stores. In particular embodiments, an edge 506 may be automatically formed by social-networking system 460 in response to a particular user action. As an example and not by way of limitation, if a first user uploads a picture, watches a movie, or listens to a song, an edge 506 may be formed between user node 502 corresponding to the first user and concept nodes 504 corresponding to those concepts. Although this disclosure describes forming particular edges 506 in particular manners, this disclosure contemplates forming any suitable edges 506 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more web pages, in one or more e-mails, or in connection with search results requested by a user. In addition or as an alternative, an advertisement may be one or more sponsored stories (e.g., a news-feed or ticker item on social-networking system 460). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system 460. In addition or as an alternative, the social action may be promoted outside or off of social-networking system 460, where appropriate. In particular embodiments, a page may be an on-line presence (such as a webpage or website within or outside of social-networking system 460) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 460. Sponsored stories are more likely to be viewed by users, at least in part because sponsored stories generally involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. Patent Application Publication No. 2012/0203831, entitled “Sponsored Stories Unit Creation from Organic Activity Stream” and filed 3 Feb. 2012 as U.S. patent application Ser. No. 13/020,745, or U.S. Patent Application Publication No. 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation.

As described above, an advertisement may be text (which may be HTML-linked), one or more images (which may be HTML-linked), one or more videos, audio, one or more ADOBE FLASH files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. An advertisement may be displayed within dedicated pages, requiring the user to interact with or watch the advertisement before the user may access a page, utilize an application, or play a game. The user may, for example view the advertisement through a web browser.

A user may interact with an advertisement in any suitable manner. The user may click or otherwise select the advertisement, and the advertisement may direct the user (or a browser or other application being used by the user) to a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 460) or RSVP (e.g., through social-networking system 460) to an event associated with the advertisement. In addition or as an alternative, an advertisement may include social-networking-system content directed to the user. For example, an advertisement may display information about a friend of the user within social-networking system 460 who has taken an action associated with the subject matter of the advertisement.

Social-networking-system functionality or content may be associated with an advertisement in any suitable manner. For example, an advertising system (which may include hardware, software, or both for receiving bids for advertisements and selecting advertisements in response) may retrieve social-networking functionality or content from social-networking system 460 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed 5 Oct. 2010 as U.S. patent application Ser. No. 12/898,662, and in U.S. Patent Application Publication No. 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 460.

Particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 460 to identify those users. In addition or as an alternative, social-networking system 460 may use user-profile information in social-networking system 460 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 460, off or outside of social-networking system 460, or on mobile computing devices of users. When on or within social-networking system 460, such targeting may be directed to users' news feeds, search results, e-mail or other in-boxes, or notifications channels or may appear in particular area of web pages of social-networking system 460, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 460, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 460 or explicit connections of a user to a node, object, entity, brand, or page on social-networking system 460. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. 2009/0070219, entitled “Targeting Advertisements in a Social Network” and filed 20 Aug. 2008 as U.S. patent application Ser. No. 12/195,321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. 2012/0159635, entitled “Comment Plug-In for Third-Party System” and filed 15 Dec. 2010 as U.S. patent application Ser. No. 12/969,368; U.S. Patent Application Publication No. 2012/0158753, entitled “Comment Ordering System” and filed 15 Dec. 2010 as U.S. patent application Ser. No. 12/969,408; U.S. Pat. No. 7,669,123, entitled “Dynamically Providing a News Feed About a User of a Social Network” and filed 11 Aug. 2006 as U.S. patent application Ser. No. 11/503,242; U.S. Pat. No. 8,402,094, entitled “Providing a Newsfeed Based on User Affinity for Entities and Monitored Actions in a Social Network Environment” and filed 11 Aug. 2006 as U.S. patent application Ser. No. 11/503,093; U.S. Patent Application Publication No. 2012/0072428, entitled “Action Clustering for News Feeds” and filed 16 Sep. 2010 as U.S. patent application Ser. No. 12/884,010; U.S. Patent Application Publication No. 2011/0004692, entitled “Gathering Information about Connections in a Social Networking Service” and filed 1 Jul. 2009 as U.S. patent application Ser. No. 12/496,606; U.S. Patent Application Publication No. 2008/0065701, entitled “Method and System for Tracking Changes to User Content in an Online Social Network” and filed 12 Sep. 2006 as U.S. patent application Ser. No. 11/531,154; U.S. Patent Application Publication No. 2008/0065604, entitled “Feeding Updates to Landing Pages of Users of an Online Social Network from External Sources” and filed 17 Jan. 2007 as U.S. patent application Ser. No. 11/624,088; U.S. Pat. No. 8,244,848, entitled “Integrated Social-Network Environment” and filed 19 Apr. 2010 as U.S. patent application Ser. No. 12/763,171; U.S. Patent Application Publication No. 2011/0083101, entitled “Sharing of Location-Based Content Item in Social-Networking Service” and filed 6 Oct. 2009 as U.S. patent application Ser. No. 12/574,614; U.S. Pat. No. 8,150,844, entitled “Location Ranking Using Social-Graph Information” and filed 18 Aug. 2010 as U.S. patent application Ser. No. 12/858,718; U.S. patent application Ser. No. 13/051,286, entitled “Sending Notifications to Users Based on Users' Notification Tolerance Levels” and filed 18 Mar. 2011; U.S. patent application Ser. No. 13/096,184, entitled “Managing Notifications Pushed to User Devices” and filed 28 Apr. 2011; U.S. patent application Ser. No. 13/276,248, entitled “Platform-Specific Notification Delivery Channel” and filed 18 Oct. 2011; or U.S. Patent Application Publication No. 2012/0197709, entitled “Mobile Advertisement with Social Component for Geo-Social Networking System” and filed 1 Feb. 2011 as U.S. patent application Ser. No. 13/019,061. Although this disclosure describes or illustrates particular advertisements being delivered in particular ways and in connection with particular content, this disclosure contemplates any suitable advertisements delivered in any suitable ways and in connection with any suitable content.

In particular embodiments, social-networking system 460 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 470 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 460 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 460 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 460 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 460 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 460 may calculate a coefficient based on a user's actions. Social-networking system 460 may monitor such actions on the online social network, on a third-party system 470, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 460 may calculate a coefficient based on the user's actions with particular types of content. The content may be associated with the online social network, a third-party system 470, or another suitable system. The content may include users, profile pages, posts, news stories, headlines, instant messages, chat room conversations, emails, advertisements, pictures, video, music, other suitable objects, or any combination thereof. Social-networking system 460 may analyze a user's actions to determine whether one or more of the actions indicate an affinity for subject matter, content, other users, and so forth. As an example and not by way of limitation, if a user frequently posts content related to “coffee” or variants thereof, social-networking system 460 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 460 may calculate a coefficient based on the type of relationship between particular objects. Referencing the social graph 500, social-networking system 460 may analyze the number and/or type of edges 506 connecting particular user nodes 502 and concept nodes 504 when calculating a coefficient. As an example and not by way of limitation, user nodes 502 that are connected by a spouse-type edge (representing that the two users are married) may be assigned a higher coefficient than a user nodes 502 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 460 may determine that the user has a higher coefficient with respect to the first photo than the second photo because having a tagged-in-type relationship with content may be assigned a higher weight and/or rating than having a like-type relationship with content. In particular embodiments, social-networking system 460 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 460 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 500. As an example and not by way of limitation, social-graph entities that are closer in the social graph 500 (i.e., fewer degrees of separation) may have a higher coefficient than entities that are further apart in the social graph 500.

In particular embodiments, social-networking system 460 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 430 of the user). A first user may be more interested in other users or concepts that are closer to the first user. As an example and not by way of limitation, if a user is one mile from an airport and two miles from a gas station, social-networking system 460 may determine that the user has a higher coefficient for the airport than the gas station based on the proximity of the airport to the user.

In particular embodiments, social-networking system 460 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 460 may provide information that is relevant to user's interests and current circumstances, increasing the likelihood that they will find such information of interest. In particular embodiments, social-networking system 460 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 460 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 460 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 470 (e.g., via an API or other communication channel), or from another suitable system. In response to the request, social-networking system 460 may calculate the coefficient (or access the coefficient information if it has previously been calculated and stored). In particular embodiments, social-networking system 460 may measure an affinity with respect to a particular process. Different processes (both internal and external to the online social network) may request a coefficient for a particular object or set of objects. Social-networking system 460 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

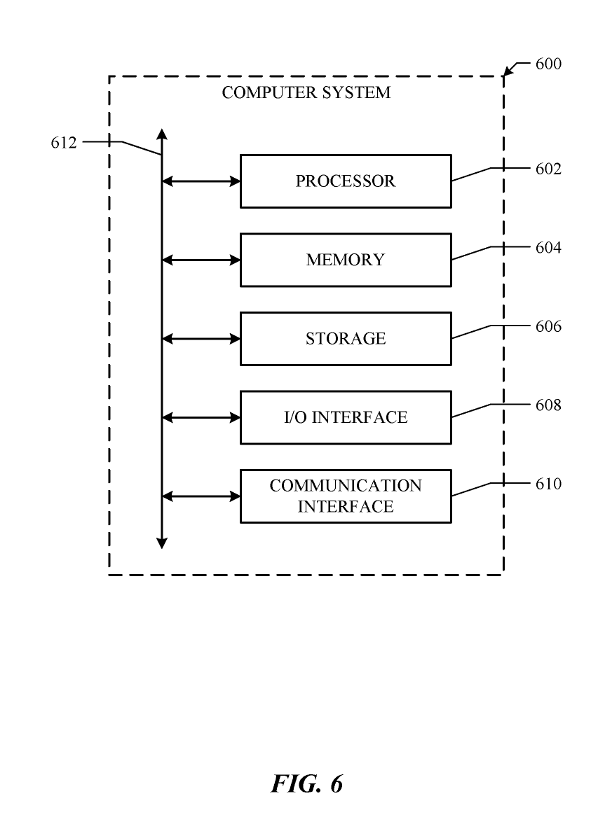

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
receiving, from a client device of an entity, a request to initiate a messaging campaign, wherein the request comprises one or more campaign rules for the messaging campaign;
sending, to each of a plurality of users, one or more messages associated with the messaging campaign;
receiving, from each of the plurality of users, a response to each of the one or more messages;
updating campaign data associated with the messaging campaign based on the responses from each of the plurality of users;
accessing user data associated with a first user of a social-networking system;
accessing the updated campaign data of the plurality of users;
determining, by a machine-learning model, a message associated with the messaging campaign, wherein the message:
is based on the user data of the first user and the updated campaign data of the plurality of users; and
satisfies the one or more rules for the messaging campaign; and
generating the message for presentation to the first user.

2. The method of claim 1, further comprising sending the message to a client device associated with the first user.

3. The method of claim 1, wherein the user data comprises conversion data or social-networking data specific to the first user.

4. The method of claim 1, wherein the campaign rules comprise a start date of the campaign and an end date of the campaign.

5. The method of claim 1, wherein the machine learning model is trained using data from lookalike users with respect to the first user, wherein:
the lookalike users are selected from a plurality of second users;
wherein the first user corresponds to a first user-vector and the plurality of second users correspond to a plurality of second user-vectors, respectively;
each user-vector is an N-dimensional vector representing the respective user in an N-dimensional vector space, each dimension of the user-vector corresponding to a social-networking trait of the respective user, and
each lookalike user is selected based on a vector similarity between the first user-vector and the second-user vector corresponding to the lookalike user.

6. The method of claim 1, wherein the campaign rules comprise a rule to modify the message if the messaging campaign is within a threshold number of days from an end date of the messaging campaign.

7. The method of claim 1, wherein the one or more campaign rules comprise a discount range on an offer within the message.

8. The method of claim 7, wherein the campaign rules comprise a rule to increase the discount if the messaging campaign is within a threshold number of days from an end date of the messaging campaign.

9. One or more computer-readable non-transitory storage media comprising software that is operable when executed to:
receive, from a client device of an entity, a request to initiate a messaging campaign, wherein the request comprises one or more campaign rules for the messaging campaign;
send, to each of a plurality of users, one or more messages associated with the messaging campaign;
receive, from each of the plurality of users, a response to each of the one or more messages;
update campaign data associated with the messaging campaign based on the responses from each of the plurality of users;
access user data associated with a first user of a social-networking system;
access the updated campaign data of the plurality of users;
determine, by a machine-learning model, a message associated with the messaging campaign, wherein the message:
is based on the user data of the first user and the updated campaign data of the plurality of users; and
satisfies the one or more rules for the messaging campaign; and
generating the message for presentation to the first user.

10. The media of claim 9, wherein the software is further operable when executed to send the message to a client device associated with the first user.

11. The media of claim 9, wherein the user data comprises conversion data or social-networking data specific to the first user.

12. The media of claim 9, wherein the campaign rules comprise a start date of the campaign and an end date of the campaign.

13. The media of claim 9, wherein the machine learning model is trained using data from lookalike users with respect to the first user, wherein:
the lookalike users are selected from a plurality of second users;
wherein the first user corresponds to a first user-vector and the plurality of second users correspond to a plurality of second user-vectors, respectively;
each user-vector is an N-dimensional vector representing the respective user in an N-dimensional vector space, each dimension of the user-vector corresponding to a social-networking trait of the respective user, and
each lookalike user is selected based on a vector similarity between the first user-vector and the second-user vector corresponding to the lookalike user.

14. The media of claim 9, wherein the campaign rules comprise a rule to modify the message if the messaging campaign is within a threshold number of days from an end date of the messaging campaign.

15. The media of claim 9, wherein the one or more campaign rules comprise a discount range on an offer within the message.

16. The method of claim 15, wherein the campaign rules comprise a rule to increase the discount if the messaging campaign is within a threshold number of days from an end date of the messaging campaign.

17. A system comprising:
one or more processors; and
one or more computer-readable non-transitory storage media coupled to one or more of the processors and comprising instructions operable when executed by one or more of the processors to cause the system to:
receive, from a client device of an entity, a request to initiate a messaging campaign, wherein the request comprises one or more campaign rules for the messaging campaign;
send, to each of a plurality of users, one or more messages associated with the messaging campaign;
receive, from each of the plurality of users, a response to each of the one or more messages;
update campaign data associated with the messaging campaign based on the responses from each of the plurality of users;
access user data associated with a first user of a social-networking system;
access the updated campaign data of the plurality of users;
determine, by a machine-learning model, a message associated with the messaging campaign, wherein the message:
is based on the user data of the first user and the updated campaign data of the plurality of users; and
satisfies the one or more rules for the messaging campaign; and
generating the message for presentation to the first user.

18. The system of claim 17, wherein the software is further operable when executed to send the message to a client device associated with the first user.

19. The system of claim 17, wherein the user data comprises conversion data or social-networking data specific to the first user.

20. The system of claim 17, wherein the campaign rules comprise a start date of the campaign and an end date of the campaign.
